(19) United States
(12) Patent Application Publication
(10) Pub. No.: US 2018/0115021 A1
(43) Pub. Date: Apr. 26, 2018

(54) LITHIUM BATTERY AND METHOD FOR MANUFACTURING SAME

(71) Applicant: ELECTRONICS AND TELECOMMUNICATIONS RESEARCH INSTITUTE, Daejeon (KR)

(72) Inventors: Young-Gi LEE, Daejeon (KR); Dong Ok SHIN, Daejeon (KR); Kwang Man KIM, Daejeon (KR)

(73) Assignee: ELECTRONICS AND TELECOMMUNICATIONS RESEARCH INSTITUTE, Daejeon (KR)

(21) Appl. No.: 15/715,484

(22) Filed: Sep. 26, 2017

(30) Foreign Application Priority Data
Oct. 24, 2016 (KR) 10-2016-0138704
Mar. 15, 2017 (KR) 10-2017-0032721

(51) Int. Cl. H01M 10/0585; H01M 10/0525; H01M 10/0567; H01M 4/04

(52) U.S. Cl. CPC H01M 10/0585; H01M 10/0525; H01M 2004/021; H01M 4/0416; H01M 4/0404; H01M 10/0567

(57) ABSTRACT

Provided is a method for manufacturing a lithium battery, wherein the method may include preparing a first electrode structure including a first current collector, a first electrode layer, and first electrode columns, which are stacked, preparing a second electrode structure including a second current collector and a second electrode layer, and forming an electrolyte between the first electrode structure and the second electrode structure, the electrolyte may extend in between the first electrode columns, and the forming of the electrolyte may include preparing a mixture including inorganic particles, a polymer, and an organic solution, preparing a liquid-state mixture by heating the mixture, and applying the liquid-state mixture onto the first electrode columns, and the polymer may have nitrile groups.

### CROSS-REFERENCE TO RELATED APPLICATIONS

This U.S. non-provisional patent application claims priority under 35 U.S.C. § 119 of Korean Patent Application Nos. 10-2016-0138704, filed on Oct. 24, 2016, and 10-2017-0032721, filed on Mar. 15, 2017, the entire contents of which are hereby incorporated by reference.

### BACKGROUND

The present disclosure herein relates to a lithium battery, and more particularly, to an electrode for a lithium battery and a method for manufacturing the same.

As the importance of energy storage and conversion techniques increases, interest in lithium batteries is increasing. Such lithium batteries may include a cathode, an anode, and an electrolyte. The lithium batteries may have a high energy density, and be reduced in size and weight. Accordingly, such lithium batteries may be utilized as a power source for mobile electronic devices and the like.

A carbonate solvent with a lithium salt (LiPF₆) dissolved therein is widely used as an organic liquid electrolyte. Such organic liquid electrolytes have high lithium ion mobility and thus exhibit excellent electrochemical properties, but safety concerns have been voiced with regard to high flammability and volatility, and leakage.

Inorganic solid electrolytes can achieve stability and mechanical strength. Oxide solid electrolytes and sulfide solid electrolytes are widely used as such inorganic solid electrolytes. The oxide solid electrolytes give rise to grain boundary resistance, and thus may be required to be manufactured in bulk forms. The sulfide solid electrolytes have excellent ionic conductivity, but are sensitive to moisture, and thus are limited in that such sulfide solid electrolytes can only be manufactured under inert atmospheres.

### SUMMARY

It is an object of the present disclosure to provide a lithium battery having enhanced efficiency and charge-discharge properties, and a method for manufacturing the same.

It is another object of the present disclosure to provide an electrolyte having enhanced ionic conductivity and mechanical strength, and a method for preparing the same.

Objects of the present disclosure are not limited to those discussed above, and other objects not discussed above will be clearly understood by a person with ordinary skill in the art from the description below.

The present disclosure relates to a lithium battery and a method for manufacturing the same. An embodiment of the inventive concept provides a method for manufacturing a lithium battery, the method including preparing a first electrode structure including a first current collector, a first electrode layer, and first electrode columns, which are stacked; preparing a second electrode structure including a second current collector and a second electrode layer; and forming an electrolyte between the first electrode structure and the second electrode structure. The forming of the electrolyte may include preparing a mixture including inorganic particles, a polymer, and an organic solution, preparing a liquid-state mixture by heating the mixture, and applying the liquid-state mixture onto the first electrode columns, and the polymer may have nitrile groups.

In an embodiment, the second electrode structure may further include second electrode columns, which are on the second electrode layer and electrically connected to the second electrode layer, and the second electrode columns may be spaced apart from each other.

In an embodiment, the preparing of the first electrode structure may include forming on the first electrode layer, a first mask pattern having openings; and forming the first electrode columns in the openings by applying an electrode slurry onto the first electrode layer

In an embodiment, wherein one of the nitrile groups interacts with the inorganic particles; and another one of the nitrile groups interacts with the lithium ions.

In an embodiment, the first electrode columns may be disposed on the first electrode layer and electrically connected to the first electrode layer

In an embodiment, the first electrode columns may include the same material as the first electrode layer

In an embodiment, the mixture may not include a cosolvent

In an embodiment, the preparing of the liquid-state mixture may be performed at 60 to 150° C.

In an embodiment of the inventive concept, a lithium battery includes a first electrode structure including a first current collector, a first electrode layer, and first electrode columns; a second electrode structure including a second current collector and a second electrode layer; and an electrolyte provided between the first electrode structure and the second electrode structure, wherein the electrolyte extends in between the first electrode columns. The electrolyte may include inorganic particles, a polymer having nitrile groups, and an organic solution, which is provided between the inorganic particles and the polymer, and includes lithium ions.

In an embodiment, interactions may be provided between the inorganic particles and one of the nitrile groups; and interactions may be provided between the lithium ions and another one of the nitrile groups.

In an embodiment, the interactions between one of the nitrile groups and the inorganic particles and the interactions between another one of the nitrile groups and the lithium ions may include dipole interactions.

In an embodiment, still another two of the nitrile groups may interact with each other.

In an embodiment, second electrode columns may be further included on the second electrode layer, and the electrode may extend in between the second electrode columns and thereby contact the second electrode columns and the second electrode layer

In an embodiment, the first electrode columns may include the same material as the first electrode layer; and the first electrode columns may be electrically connected to the first electrode layer.

### BRIEF DESCRIPTION OF THE FIGURES

In order to provide assistance and further understanding of the inventive concept, references are provided along with descriptions of the accompanying drawings, and reference numerals are given below.

FIG. 1A is a cross-sectional view illustrating a lithium battery according to an embodiment of the inventive concept;

FIG. 1B is a perspective view illustrating a first electrode structure according to an embodiment of the inventive concept;

FIG. 1C is a perspective view illustrating a second electrode structure according to an embodiment of the inventive concept;

FIG. 1D is an enlarged view of area D in FIG. 1A;

FIGS. 2A to 2E are cross-sectional views illustrating a manufacturing process for a lithium battery according to an embodiment of the inventive concept;

FIG. 3 is a graph showing the results of evaluating ionic conduction properties of Experimental Examples 3-1 and 3-2, and Comparative Example 3;

FIG. 4 is a graph showing the results of evaluating capacity properties of Comparative Example 4 and Experimental Example 4; and

FIG. 5 is a graph showing the results of evaluating capacity properties of Comparative Example 5 and Experimental Example 5.

### DETAILED DESCRIPTION

In order to provide a more complete understanding of the features and effects of the inventive concept, exemplary embodiments of the inventive concept are described with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. A person with ordinary skill in the art will understand the appropriate conditions for carrying out the inventive concept.

The terminology used herein is for the purpose of describing particular embodiments only and is not intended to be limiting of the invention. As used herein, singular forms are intended to include their plural forms as well, unless the context clearly indicates otherwise. The terms “comprises” and/or “comprising”, when used in this specification, specify the presence of stated features, steps, operations, and/or elements, but do not preclude the presence or addition of one or more other features, steps, operations, and/or elements thereof.

In this specification, when a film (or layer) is referred to as being ‘on’ another film (or layer) or substrate, it can be formed directly on the other film (or layer) or substrate, or intervening layers may also be present.

In the specification, although the terms first, second, third, etc. are used in various embodiments to describe various regions, films (or layers), etc., these regions or films should not be limited by these terms. These terms are only used to distinguish one region or film (or layer) from another region or film (or layer). Thus, a film termed a first film in one embodiment could be termed a second film in another embodiment. Exemplary embodiments described herein also include complementary embodiments thereof. Like reference numerals refer to like elements throughout.

Unless otherwise defined, all terms used herein used in the embodiments of the inventive concept have the same meaning as commonly understood by one of ordinary skill in the art to which this invention belongs.

Hereinafter, a lithium battery and a method for manufacturing the same according to embodiments of the inventive concept will be described in detail with reference to the accompanying drawings.

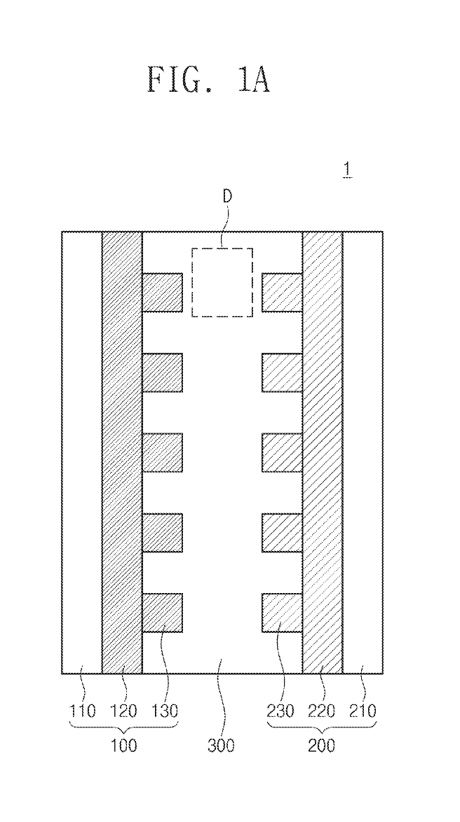

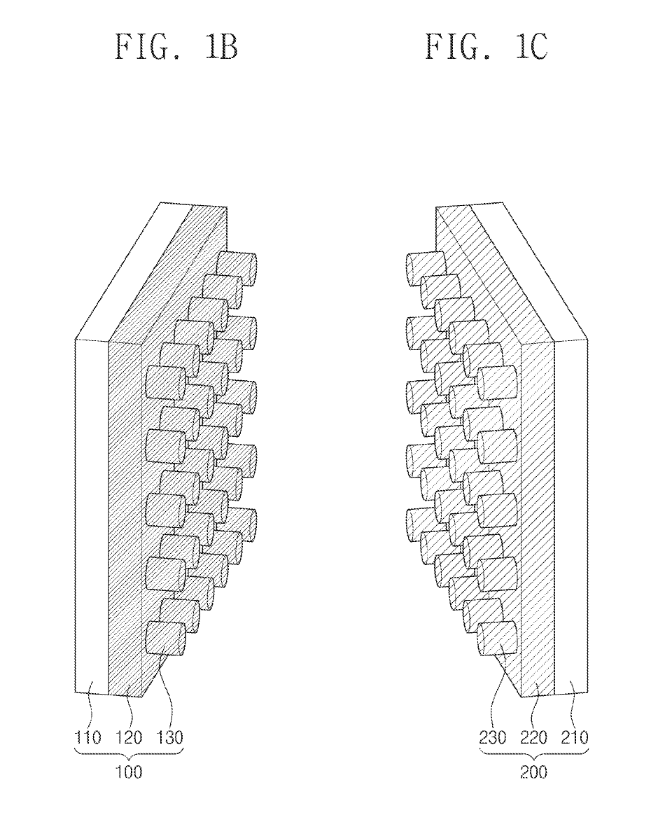

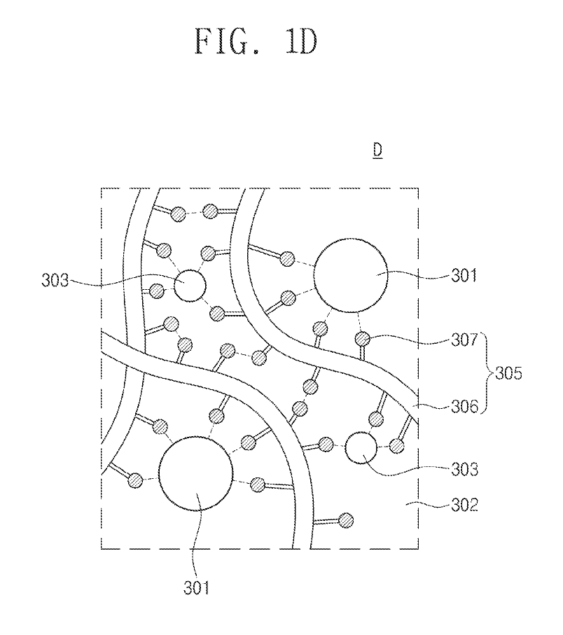

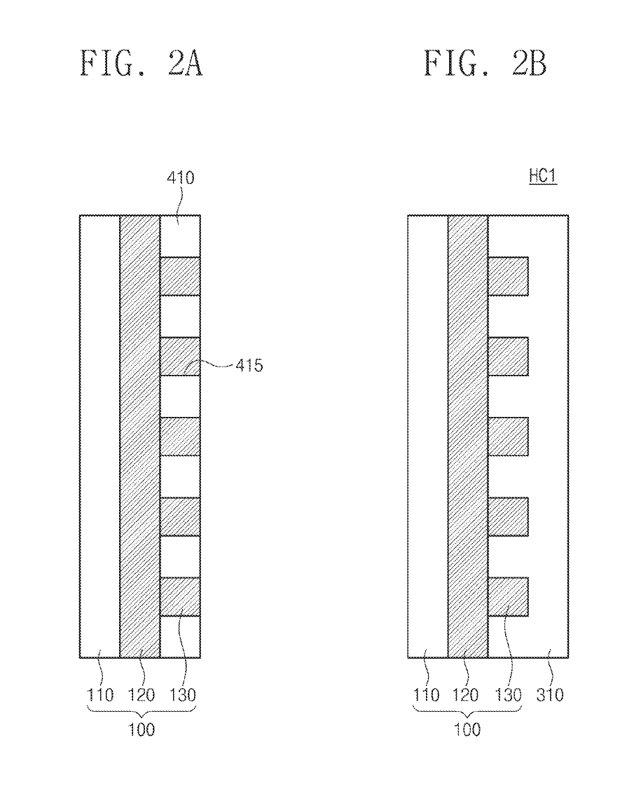

FIG. 1A is a cross-sectional view illustrating a lithium battery according to an embodiment of the inventive concept. FIG. 1B is a perspective view illustrating a first electrode structure according to an embodiment of the inventive concept, and corresponds to a perspective view of a first electrode structure in FIG. 1A. FIG. 1C is a perspective view illustrating a second electrode structure according to an embodiment of the inventive concept, and corresponds to a perspective view of a second electrode structure in FIG. 1A.

Referring to FIGS. 1A to 1C, a lithium battery 1 may include a first electrode structure 100, a second electrode structure 200, and an electrolyte 300. The second electrode structure 200 may be spaced apart from, and face, the first electrode structure 100. The electrolyte 300 may be interposed between the first electrode structure 100 and the second electrode structure 200. Ions (not shown) may move between the first electrode structure 100 and the second electrode structure 200, through the electrolyte 300.

The first electrode structure 100 may include a first current collector 110, a first electrode layer 120, and first electrode columns 130. The first electrode structure 100 may function as a cathode structure. The first current collector 110 may include a metal, such as aluminum. The first electrode layer 120 may be disposed on the first current collector 110. The first electrode layer 120 may be electrically connected to the first current collector 110. The first electrode layer 120 may include a cathode active material, a conductive material, and a binder. The cathode active material may include lithium cobalt oxide (LiCoO₂), lithium nickel oxide (LiNiO₂), lithium manganese oxide (LiMn₂O₄), nanosized olivine (LiFePO₄) coated with carbon particles, or a mixed body or solid solution thereof. The binder may include a fluoropolymer, such as polyvinylidene fluoride. The first electrode columns 130 may be disposed on the first electrode layer 120. The first electrode columns 130 may protrude toward the second electrode structure 200. The first electrode columns 130 may be spaced apart from each other. The first electrode layer 120 may be exposed by the first electrode columns 130. The first electrode columns 130 may include the same material as the first electrode layer 120. The ratio of components in the first electrode columns 130 may be the same as or different from the ration of components in the first electrode layer 120. As in FIG. 1B, the first electrode columns 130 may be cylindrical. In another example, the first electrode columns 130 may be in the form of a polyhedron, such as a tetrahedron or a hexahedron. The flexibility of the first electrode structure 100 may be enhanced by the first electrode columns 130. Even if the lithium battery 1 is bent, the first electrode structure 100 may not be damaged by the bending. Accordingly, the lithium battery 1 may be used in a wearable element, such as a flexible element.

The second electrode structure 200 may include a second current collector 210, a second electrode layer 220, and second electrode structures 230. The second electrode structure 200 may function as an anode structure. The second current collector 210 may include a metal, such as copper. The second electrode layer 220 may be disposed on the second current collector 210. The second electrode layer 220 may be electrically connected to the second current collector 210. The second electrode layer 220 may include an anode active material, a conductive material, and a binder. The anode active material may include a carbonaceous material (for example, graphite, hard carbon, or soft carbon) or a non-carbonaceous material (for example, tin, silicon, lithium titanium oxide (LiₓTiO₂), a nanotube, or a spinel lithium titanium oxide (Li₄Ti₅O₁₂) coated with carbon particles). The conductive material and the binder may include the same materials as described above in examples given for the first electrode structure 100. The second electrode columns 230 may be disposed on the second electrode layer 220. As in FIG. 1C, the second electrode columns 230 may be cylindrical. In another example, the second electrode columns 230 may be in the form of a polyhedron. The second electrode columns 230 may protrude toward the first electrode structure 100. The second electrode columns 230 may be spaced apart from each other. The second electrode layer 220 may be exposed by the second electrode columns 230. The flexibility of the second electrode structure 200 may be enhanced by the second electrode columns 230. The second electrode columns 230 may be electrically connected to the second electrode layer 220. The second electrode columns 230 may include the same material as the second electrode layer 220. The ratio of components in the second electrode columns 230 may be the same or different from the ratio of components in the second electrode layer 220.

The electrolyte 300 may be interposed between the first electrode layer 120 and the second electrode layer 220. The electrolyte 300 may extend in between the first electrode columns 130 and be filled in between the first electrode columns 130. The electrolyte 300 may contact the first electrode columns 130 and the first electrode layer 120. Thereby, the contact area between the first electrode structure 100 and the electrolyte 300 may be increased. Consequently, the electrical properties (for example, battery efficiency or charge-discharge properties) of the lithium battery 1 may be enhanced. The lithium battery 1 may be reduced in size. The electrolyte 300 may extend in between the second electrode columns 230 and be filled in between the second electrode columns 230. The electrolyte 300 may contact the second electrode columns 230 and the second electrode layer 220. The contact area between the second electrode structure 200 and the electrolyte 300 may be increased. The electrical properties of the lithium battery 1 may be further enhanced. Hereinafter, the electrolyte 300 according to embodiments is described in greater detail.

FIG. 1D is an enlarged view of area D in FIG. 1A.

Referring to FIGS. 1A to 1D, an electrolyte 300 may include inorganic particles 301, an organic solution 302, and a polymer 305. The inorganic particles 301 may include a plurality of the inorganic particles 301, and be spaced apart from each other. Each of the inorganic particles 301 may include a ceramic. In an example, the inorganic particles 301 may include a phosphate material having a NASICON structure. The phosphate material may include lithium aluminum titanium phosphate (LATP) or lithium aluminum germanium phosphate (LAGP). In another example, the inorganic particles 301 may include at least one among lithium lanthanum zirconium oxide (LLZO) having a garnet structure, a lithium lanthanum titanium oxide (LLTO) based material having a perovskite structure, lithium borohydride (LiBH₄), and lithium amide (LiNH₂).

The organic solution 302 may be provided between the inorganic particles 301 and the polymer 305. The organic solution 302 may be prepared by dissolving a lithium salt in an organic solvent. Accordingly, the organic solution 302 may include lithium ions 303. In an example, the organic solvent may include ethylene carbonate. In another example, the organic solvent may further include at least one among fluorine-substituted ethylene carbonate, propylene carbonate, fluorine-substituted propylene carbonate, gamma-butyrolactone, fluorine-substituted gamma-butyrolactone, and ethyl methyl carbonate. The lithium salt may include at least one among lithium perchlorate (LiClO₄), lithium triflate (LiCF₃SO₃), lithium hexafluorophosphate (LiPF₆), lithium tetrafluoroborate (LiBF₄), and lithium trifluoromethanesulfonyl imide (LiN(CF₃SO₂)₂).

The polymer 305 may include a polymer chain 306 and functional groups 307. The polymer 305 may include at least one among acrylonitrile polymers and copolymers thereof. In another example, the polymer 305 may further include a cellulose polymer. The acrylonitrile polymer and the cellulose polymer may be mixed at a weight ratio of about 100:0 to 50:50. The polymer chain 306 may have a matrix structure. The functional groups 307 may be attached to the polymer chain 306. For example, the functional groups 307 may include nitrile groups. The functional groups 307 may have strong polarity in the organic solution 302. In FIG. 1D, the dotted lines indicate the interactions of the functional groups 307. At least one of the functional groups 307 may interact with the inorganic particles 301. Another one of the functional groups 307 may interact with the lithium ions 303. Accordingly, the ionic conductivity of the electrolyte 300 may be enhanced. Another two of the functional groups 307 may interact with each other. The polymer chain 306 may be fixed by the interactions of the functional groups 307, and consequently, the mechanical strength of the electrolyte 300 may be enhanced. In an example, the interactions between the functional groups 307 and the inorganic particles 301, the interactions between the functional groups 307 and the lithium ions 303, and the interactions amongst the functional groups 307 may include dipole-dipole interactions. Due to such interactions, the organic solution 302 content in the electrolyte 300 may be increased. For example, the organic solution 302 may be about 400 to 800 wt % of the polymer 305. The organic solution 302 content may increase, thereby further increasing the ionic conductivity of the electrolyte 300.

The functional groups 307 may fix the inorganic particles 301, the lithium ions 303, and the polymer chain 306. Accordingly, the electrolyte 300 may not flow at room temperature (for example, 25° C.), and may be in a semi-solid state. Leakage, and the volatility and flammability of the electrolyte 300 may be decreased. When the amount of the organic solution 302 exceeds about 800 wt % of the polymer 305, the electrolyte 300 may have flowability at room temperature.

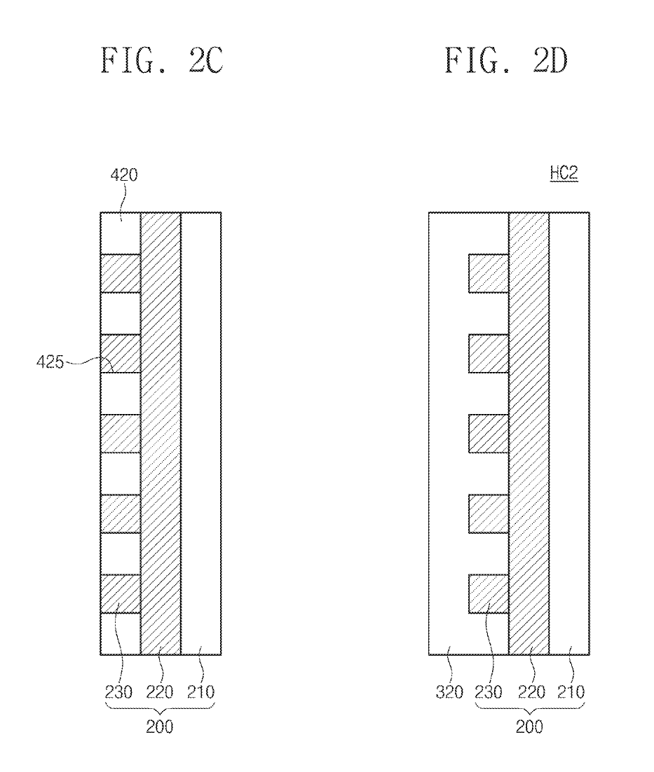

FIGS. 2A to 2E are cross-sectional views illustrating a manufacturing process for a lithium battery according to an embodiment of the inventive concept. Descriptions already given above are not repeated below.

Referring to FIG. 2A, a first electrode layer 120 and first electrode columns 130 may be formed on a first current collector 110 to manufacture a first electrode structure 100. For example, an aluminum plate may be used as the first current collector 110. The first electrode layer 120 may be formed by applying a first cathode slurry onto the first current collector 110. A first electrode slurry may include a cathode active material, a conductive material, and a binder. Drying and rolling operations may be performed on the first electrode layer 120. The rolling operation may reduce the thickness of first electrode layer 120. Afterwards, a first mask pattern 410 may be formed on the first electrode layer 120. The first mask pattern 410 may have first openings 415 that expose the top face of the first electrode layer 120.

A second cathode slurry may be applied onto the first electrode layer 120 by a screen-printing technique or a nozzle-spraying technique. Here, the second cathode slurry may include the same material as the first cathode slurry. The second cathode slurry may have the same or a different ratio of components as the first cathode slurry. The second slurry may be filled into the first openings 415 in the first mask pattern 410 to form the first electrode columns 130. The first electrode columns 130 may be physically and electrically connected to the first electrode layer. Afterwards, the first mask pattern 410 may be removed.

Referring to FIG. 2B, a first sub electrolyte 310 may be formed on the first electrode columns 130 to manufacture a first half-cell HC1. For example, inorganic particles 301, an organic solution 302, and a polymer 305 may be mixed to prepare a mixture. The inorganic particles 301, the organic solution 302, and the polymer 305 may include the same materials as described above with reference to FIG. 1D. According to embodiments, the mixture may be in a semi-solid state at room temperature due to interactions of functional groups 307 in the polymer 305. A liquid-state mixture may be prepared by heating the mixture to about 60 to 150° C. In the present disclosure, a mixture being in a liquid state may indicate that the mixture has flowability. When the mixture is heated to a temperature below about 60° C., the mixture may not have flowability. When the mixture is heated to a temperature above about 150° C., the mixture may harden or deform. When the amount of the organic solution 302 is less than about 400 wt % of the polymer 305, the mixture may not flow in a temperature range of about 60 to 150° C. The liquid-state mixture may be applied onto the first electrode columns 130 to form the first sub electrolyte 310. Application of the mixture may be performed by a casting operation. The first sub electrolyte 310 may be formed in between the first electrode columns 130. The mixture has flowability, and thus the first sub electrolyte 310 may be easily filled in between the first electrode columns 130. According to embodiments, the flowability of the mixture may be controlled by adjusting the temperature. The mixture may not include an additional cosolvent such as n-methyl pyrrolidone (NMP). The cosolvent may perform the role of causing the mixture to flow. Afterwards, the first sub electrolyte 310 may be cooled to room temperature such that the first sub electrolyte 310 does not have flowability. Accordingly, the mechanical/physical strength of the first sub electrolyte 310 may be enhanced.

Referring to FIG. 2C, a second current collector 210, a second electrode layer 220, and second electrode columns 230 may be formed to manufacture a second electrode structure 200. For example, a copper plate may be used as the second current collector 210. The second electrode layer 220 may be formed by applying a first anode slurry onto the second current collector 210. The first anode slurry may include an anode active material, a conductive material, and a binder. A second mask pattern 420 may be formed on the second electrode layer 220. Second openings 425 in the second mask pattern 420 may expose the second electrode layer 220. A second anode slurry may be applied onto the second electrode layer 220 by a screen-printing technique or a nozzle-spraying technique. The second anode slurry may be provided inside the second openings 425 in the second mask pattern 420 to form the second electrode columns 230. The second anode slurry may include the same material as the first anode slurry. Afterwards, the second mask pattern 420 may be removed.

Referring to FIG. 2D, a second sub electrolyte 320 may be formed on the second electrode columns 230 to manufacture a second half-cell HC2. The same mixture as that described with reference to FIG. 2 may be prepared. The mixture may not include an additional cosolvent such as n-methyl pyrrolidone (NMP). A liquid-state mixture may be prepared by heating the mixture to about 60 to 150° C. The liquid-state mixture may be applied onto the second electrode columns 230 to form the second sub electrolyte 320. The mixture has flowability, and thus the second sub electrolyte 320 may be easily filled in between the second electrode columns 230. The second sub electrolyte 320 may be cooled to room temperature. The second sub electrolyte 320 may include the same material as the first sub electrolyte 310.

Referring to FIG. 2E, the second half-cell HC2 may be disposed on the first half-cell HC1 such that the second sub electrolyte 320 faces the first sub electrolyte 310. The second sub electrolyte 320 may be electrically and physically connected to the first sub electrolyte 310 to form an electrolyte 300. Since the second sub electrolyte 320 includes substantially the same material as the first sub electrolyte 310, the interfacial resistance between the first sub electrolyte 310 and the second sub electrolyte 320 may be reduced. Accordingly, the ionic conductivity of the electrolyte 300 may be enhanced. The first electrode layer 120, the first electrode columns 130, the second electrode layer 220, or the second electrode columns 230 may be damaged by a cosolvent. As described with reference to FIG. 2B, the mixture does not include a cosolvent, and the electrolyte 300 may be prepared using the mixture. Thus, damage to the first electrode layer 120, the first electrode columns 130, the second electrode layer 220, or the second electrode columns 230 may be prevented. A lithium battery 1 may be completed according to the manufacturing example described to this point.

Hereinafter, a method for manufacturing a lithium battery according to an embodiments of the inventive concept, and results of evaluating properties are described in greater detail with reference to experimental examples of embodiments of the inventive concept.

### Manufacture of First Electrode (Cathode) Structures

### Comparative Example 1

An electrode slurry is prepared by dissolving 90 wt % of lithium cobalt oxide, 5 wt % of carbon black, and 5 wt % of polyvinylidene fluoride in n-methyl pyrrolidone (NMP). Here, polyvinylidene fluoride having a molecular weight (M.w.) of 250,000 g/mol was used. An electrode layer is formed by coating the electrode slurry onto an aluminum plate (current collector). The electrode layer is dried and rolled. The rolling operation is carried out until the electrode layer has a thickness of 150 μm.

### Experimental Example 1

An electrode slurry is prepared by dissolving 90 wt % of lithium cobalt oxide, 5 wt % of carbon black, and 5 wt % of polyvinylidene fluoride in n-methyl pyrrolidone (NMP). Here, polyvinylidene fluoride having a molecular weight (M.w.) of 250,000 g/mol was used.

An electrode layer is formed by coating the electrode slurry onto an aluminum plate (current collector). The electrode layer is dried and rolled. The rolling operation is carried out until the electrode layer has a thickness of 100 μm. A mask pattern is formed on the electrode layer. The mask pattern has openings that expose the electrode layer. The electrode slurry is applied onto the electrode layer and the mask pattern by a nozzle spray printing technique. Afterwards, the mask pattern is removed. The manufactured electrode columns were observed to be cylindrical. The average diameter of the electrode columns was measured to be 50 μm. The average height of the electrode columns was measured to be 50 μm. The average spacing between the electrode columns was measured to be 50 μm.

### Manufacture of Second Electrode (Anode) Structures

### Comparative Example 2

An electrode structure was manufactured according to the same method as in Comparative Example 1, other than that a copper plate, rather than the aluminum plate, was used as the current collector. Natural graphite was used instead of lithium cobalt oxide.

### Experimental Example 2

An electrode structure was manufactured the same as in Experimental Example 1, other than that a copper plate, rather than the aluminum plate, was used as the current collector. Natural graphite was used instead of lithium cobalt oxide.

### Preparation of Electrolyte

### Comparative Example 3

An organic solvent is prepared by mixing ethylene carbonate (EC) and propylene carbonate (PC). Lithium hexafluorophosphate (LiPF₆) is dissolved in the organic solvent to prepare a 1 M organic solution. A mixture is prepared by mixing 9 wt % of a copolymer of vinylidene fluoride and hexafluoropropylene, 36 wt % of the organic solution, and 55 wt % of acetone. An electrolyte is prepared by casting the mixture onto a Teflon plate. The prepared electrolyte was observed to be in a gel state.

### Experimental Example 3-1

A mixture is prepared by mixing 13 wt % of polyacrylonitrile (polymer), 6 wt % of lithium aluminum titanium phosphate, and 81 wt % of an organic solution. Cosolvents, such as n-methyl pyrrolidone (NMP), are not added. The organic solvent used is 1 M of a lithium salt (LiPF₆) dissolved in ethylene carbonate. A liquid-state mixture is prepared by melting the mixture at 80° C. An electrolyte in a film state is formed by casting the liquid mixture onto a Teflon plate.

### Experimental Example 3-2

An electrode structure was manufactured the same as in Experimental Example 3-1, other than that a copolymer of acrylonitrile and methyl methacrylate was used.

### Manufacture of First (Cathode) Half-Cell

### Comparative Example 4

The electrolyte in Comparative Example 3 is applied to the first electrode structure in Comparative Example 1. A cathode half-cell is manufactured by placing a lithium anode counter electrode on the electrolyte.

### Experimental Example 4

The electrolyte in Experimental Example 3-1 is applied to the first electrode structure in Experimental Example 1. A cathode half-cell is manufactured by placing a lithium anode counter electrode on the electrolyte.

### Manufacture of Second (Anode) Half-Cell

### Comparative Example 5

The electrolyte in Experimental Example 3 is applied to the second electrode structure in Experimental Example 2. An anode half-cell is manufactured by placing a lithium cathode counter electrode on the electrolyte.

### Experimental Example 5

The electrolyte in Experimental Example 3-1 is applied to the second electrode structure in Experimental Example 2. An anode half-cell is manufactured by placing a lithium cathode counter electrode on the electrolyte.

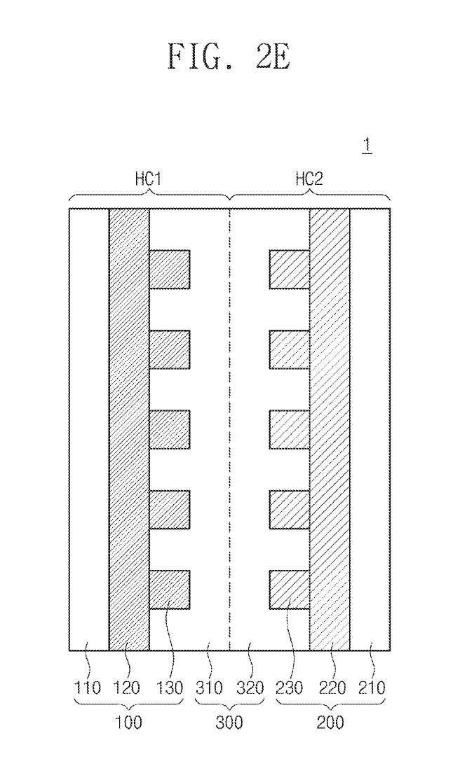

FIG. 3 is a graph showing the results of evaluating ionic conduction properties of Experimental Examples 3-1 and 3-2, and Comparative Example 3. Ionic conductivity was evaluated by measuring the ionic conductivities (vertical axis) of Experimental Examples 3-1 and 3-2, and Comparative Example 3 (horizontal axis).

Referring to FIG. 3 along with FIG. 1D, Experimental Example 3-1 e31 and Experimental Example 3-2 e32 exhibit higher ionic conductivities than Comparative Example 3-2 c3. The electrolyte in Experimental Example 3-1 e31 and the electrolyte 300 in Experimental Example 3-2 e32 may include a polymer 305 having functional groups 307. The functional groups 307 may interact with inorganic particles 301 and lithium ions 303. Thus, the ionic conductivity of the electrolyte 300 may be enhanced.

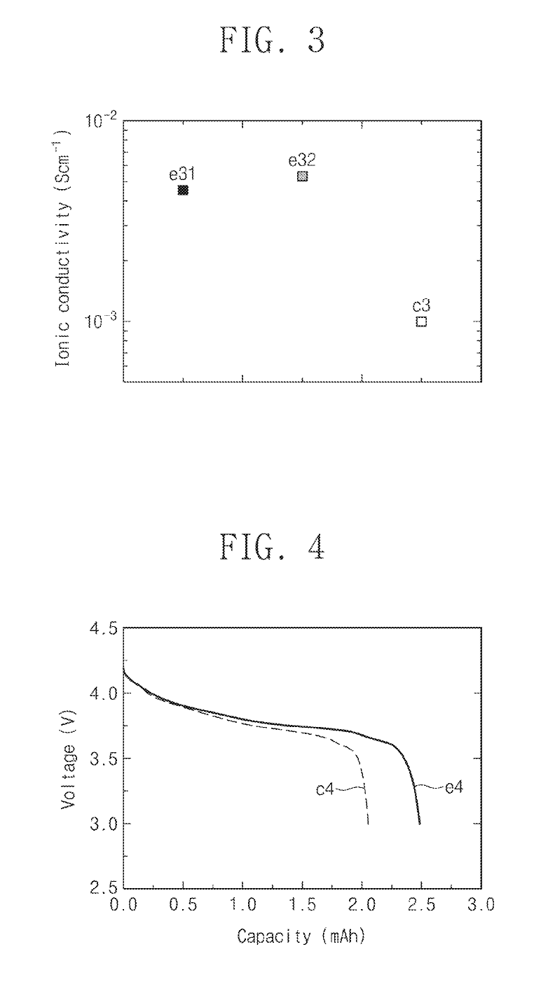

FIG. 4 is a graph showing the results of evaluating capacity properties of Comparative Example 4 and Experimental Example 4. The horizontal axis indicates capacity, and the vertical axis indicates voltage.

Referring to FIGS. 1A, 1B, 1D, and 4, Experimental Example 4 e4 exhibits higher capacity properties than Comparative Example 4 c4. Comparative Example 4 c4 may not include electrode columns. The first electrode structure 100 in Experimental Example 4 e4 includes the first electrode columns 130, and thus the contact area between the first electrode structure 100 and the electrolyte 300 may be increased. It can be seen that the capacity properties of the lithium battery 1 are therefore enhanced. In Comparative Example 4 c4, the polymer 305 does not have nitrile functional groups. The electrolyte 300 in Experimental Example 4 e4 may include the polymer 305 having the functional groups 307. The functional groups 307 may interact with the inorganic particles 301 and the lithium ions 303. The capacity properties of the lithium battery 1 may be further enhanced.

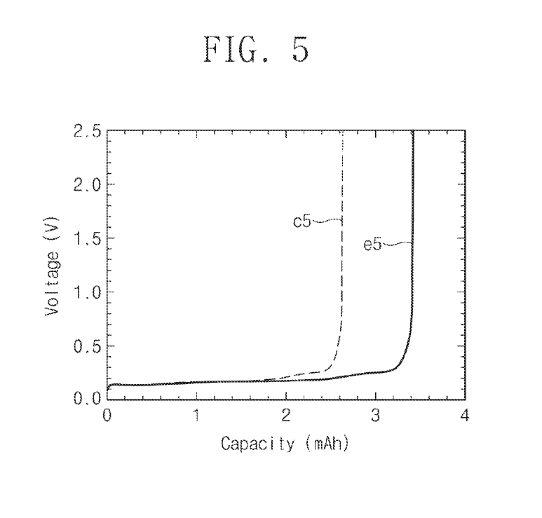

FIG. 5 is a graph showing the results of evaluating capacity properties of Comparative Example 5 and Experimental Example 5. The horizontal axis indicates capacity, and the vertical axis indicates voltage.

Referring to FIGS. 1A, 1C, 1D, and 5, Experimental Example 5 e5 exhibits higher capacity properties than Comparative Example 5 c5. Comparative Example 5 c5 may not include electrode columns. The second electrode structure 200 in Experimental Example 5 e5 includes the second electrode columns 230, and thus the contact area between the second electrode structure 200 and the electrolyte 300 may be increased. It can be seen that the capacity properties of the lithium battery 1 are therefore enhanced. In Comparative Example 5 c5, the polymer 305 does not have nitrile functional groups. The electrolyte 300 in Experimental Example 5 e5 may include the polymer 305 having the functional groups 307. The capacity properties of the lithium battery 1 may be further enhanced by the interaction of the functional groups 307.

According to an embodiment of the inventive concept, first electrode columns may be disposed on a first electrode layer. An electrolyte may extend in between the first electrode columns. The contact area may be increased between the first electrode structure and the electrolyte. The electrolyte may extend in between second electrode columns, and thereby increase the contact area between a second electrode structure and the electrolyte. Consequently, the efficiency and charge-discharge properties of a lithium battery may be enhanced.

The electrolyte may include a polymer having functional groups. The functional groups may interact with inorganic particles and lithium ions. Accordingly, the ionic conductivity of the electrolyte may be enhanced. At least two of the functional groups may interact with each other. Accordingly, the mechanical strength of the electrolyte may be enhanced. The functional groups may fix the inorganic particles, the lithium ions, and the polymer. Accordingly, the electrolyte may not flow at room temperature. Leakage, and the volatility and flammability of the electrolyte may be reduced.

Although the exemplary embodiments of the present invention have been described, it is understood that the present invention should not be limited to these exemplary embodiments but various changes and modifications can be made by one ordinary skilled in the art within the spirit and scope of the present invention.

What is claimed is:

1. A method for manufacturing a lithium battery, the method comprising:
preparing a first electrode structure including a first current collector, a first electrode layer, and first electrode columns, which are stacked;
preparing a second electrode structure including a second current collector and a second electrode layer; and
forming an electrolyte between the first electrode structure and the second electrode structure, wherein the electrolyte extends in between the first electrode columns and thereby contacts the first electrode layer and the first electrode columns, and the forming of the electrolyte includes
preparing a mixture including inorganic particles, a polymer, and an organic solution,
preparing a liquid-state mixture by heating the mixture, and
applying the liquid-state mixture onto the first electrode columns, the polymer has nitrile groups.

2. The method of claim 1, wherein the second electrode structure further includes second electrode columns, which are on the second electrode layer and electrically connected to the second electrode layer, the second electrode columns being spaced apart from each other.

3. The method of claim 1, wherein the preparing of the first electrode structure includes:
forming a first mask pattern having openings on the first electrode layer; and
forming the first electrode columns in the openings by applying an electrode slurry onto the first electrode layer.

4. The method of claim 1, wherein the first electrode columns are disposed on the first electrode layer and electrically connected to the first electrode layer.

5. The method of claim 1, wherein the first electrode columns include the same material as the first electrode layer.

6. The method of claim 1, wherein one of the nitrile groups interacts with the inorganic particles; and
another one of the nitrile groups interacts with the lithium ions.

7. The method of claim 6, wherein the mixture does not include a cosolvent.

8. The method of claim 6, wherein the preparing of the liquid-state mixture is performed at 60 to 150° C.

9. A lithium battery comprising:
a first electrode structure including a first current collector, a first electrode layer, and first electrode columns;
a second electrode structure including a second current collector and a second electrode layer; and
an electrolyte provided between the first electrode structure and the second electrode structure, wherein the electrolyte extends in between the first electrode columns and includes
inorganic particles,
a polymer having nitrile groups, and
an organic solution, which is provided between the inorganic particles and the polymer, and includes lithium ions.

10. The lithium battery of claim 9, wherein:
interactions are provided between the inorganic particles and one of the nitrile groups; and
interactions are provided between the lithium ions and another one of the nitrile groups.

11. The lithium battery of claim 10, wherein the interactions between one of the nitrile groups and the inorganic particles and the interactions between another one of the nitrile groups and the lithium ions include dipole interactions.

12. The lithium battery of claim 10, wherein still another two of the nitrile groups interact with each other.

13. The lithium battery of claim 9, further comprising second electrode columns on the second electrode layer, wherein the electrolyte extends in between the second electrode columns and thereby contacts the second electrode columns and the second electrode layer.

14. The lithium battery of claim 9, wherein:
the first electrode columns include the same material as the first electrode layer; and
the first electrode columns are electrically connected to the first electrode layer.
